(19) United States
(12) Patent Application Publication
(10) Pub. No.: US 2020/0055037 A1
(43) Pub. Date: Feb. 20, 2020

(54) TRANSITION METAL ISONITRILE CATALYSTS

(71) Applicant: Gerald S. HADEED, Port Of Spain (TT)

(72) Inventors: Gerald S. HADEED, Port Of Spain (TT); Kamaluddin ABDUR-RASHID, Mississauga, Ontario (CA)

(21) Appl. No.: 16/606,333

(22) PCT Filed: Apr. 19, 2018
(86) PCT No.: PCT/IB2018/052732

§ 371 Date: Oct. 18, 2019

Related U.S. Application Data
(60) Provisional application No. 62/487,227, filed on Apr. 19, 2017.
(60) Provisional application No. 62/572,610, filed on Oct. 16, 2017.

(51) Int. Cl. B01J 31/18

(52) U.S. Cl. CPC B01J 31/189; B01J 2531/821; B01J 2231/643; B01J 31/1805

(57) ABSTRACT

The present disclosure relates to new transition metal isonitrile compounds, processes for the production of the compounds and the use of the compounds as catalysts. The disclosure also relates to the use of the metal isonitrile compounds as catalysts for hydrogenation and transfer hydrogenation of compounds containing one or more carbon-oxygen, and/or carbon-nitrogen and/or carbon-carbon double bonds.

This application claims the priority and benefit of U.S. Provisional Patent Application 62/487,227, filed Apr. 19, 2017 and United States Provisional Patent Application 62/572,610, filed Oct. 16, 2017, which are incorporated herein by reference in their entirety.

### FIELD OF THE DISCLOSURE

The present disclosure relates to transition metal isonitrile compounds containing a tridentate aminodiphosphine ligand and the use of the compounds as catalysts for catalytic transformations. The disclosure also relates to the use of the transition metal isonitrile compounds as catalysts for hydrogenation and transfer hydrogenation of compounds containing one or more carbon-oxygen, and/or carbon-nitrogen and/or carbon-carbon double bonds.

### BACKGROUND OF THE DISCLOSURE

There are numerous reports relating to transition metal complexes that are used for organic synthesis, including hydrogenations, transfer hydrogenations, isomerizations, oxidations, hydrosilylations, hydroborations, coupling reactions, amongst others. The reactions are usually mediated by transition metal complexes in which metals such as ruthenium, rhodium, iridium, palladium, etc. are coordinated with a tertiary phosphine compound as a catalyst.

Aminodiphosphines represent a select class of compounds containing two tertiary phosphine groups and an amine group which can bind to various transition metals in a tridentate fashion. A variety of transition metal complexes containing tridentate aminodiphosphine ligands (PNHP) with a secondary amine (—NH—) group have been developed and used for a variety of catalytic transformations (U.S. Pat. No. 7,291,753 B2; U.S. Pat. No. 7,777,083 B2; U.S. Pat. No. 8,518,368 B2; U.S. Pat. No. 9,115,249 B2; D. Amoroso et al., The Strem Chemiker, 2011, 25, 4-12; T. W. Graham et al., Angew. Chem. Int. Ed. 2010, 49, 8708-8711; X. Chen et al., Dalton Trans., 2009, 1407-1410; Z. Clarke et al., Organometallics, 2006, 25, 4113-4117; M. Kaß et al., Angew. Chem. Int. Ed. 2009, 48, 905-907; M. Bertoli et al., Organometallics 2011, 30, 3479-3482; B. Askevold et al., Nature Chemistry 2011, 3, 532-536).

In the subclass of ruthenium aminodiphosphine compounds, a variety of approaches have been investigated for the development of catalysts which are stable and active for a variety of catalytic transformations. Abdur-Rashid prepared and demonstrated that ruthenium aminodiphosphine compounds of the type RuX₂(PNHP) are air-stable solids which are effective as catalysts for the hydrogenation and transfer hydrogenation of ketones and imines upon activation with a base in the presence of hydrogen gas or a hydrogen donor solvent such as 2-propanol or triethylammonium formate (K. Abdur-Rashid, U.S. Pat. No. 7,291,753 B2). Since then, there have been several attempts to develop these ruthenium aminodiphosphine catalysts by incorporation of a variety of ancillary ligands to improve the activity of the catalysts.

One such approach includes the use of another tertiary phosphine ligand as a co-ligand by preparing compounds of the type RuX₂(PNHP)(PR₃), where PR₃ represents the tertiary phosphine co-ligand (M. Kaß et al., Angew. Chem. Int. Ed. 2009, 48, 905-907; A. Staubitz et al., J. Am. Chem. Soc. 2010, 132, 13332-13345). However, the activity of such compounds is adversely affected by the steric congestion of the PR₃ co-ligand. Hence, compounds of the type RuX₂(PNHP)(PR₃) are not very effective for difficult substrates.

A related approach includes the use of pyridine as a co-ligand by preparing compounds of the type RuX₂(PNHP)(pyridine). However, the pyridine ligand is easily displaced from these complexes. Hence, compounds of the type RuX₂(PNHP)(pyridine) are not more effective than RuX₂(PNHP).

Another approach use carbon monoxide (CO) as a co-ligand by preparing compounds of the type RuX₂(CO)(PNHP) (M. Bertoli et al., Organometallics 2011, 30, 3479-3482; W. Kuriyama et al., U.S. Pat. No. 8,471,048 B2). Such compounds are also effective as catalysts, because the CO co-ligand results in less steric congestion than a PR₃ co-ligand. However, the activity of the catalysts is adversely affected by the electrophilic character of the CO ligand. As a result of this, compounds of the type RuX₂(PNHP)(CO) tends to be sluggish as catalysts, and require high catalyst loadings and prolonged reaction times.

In order to develop an effective ruthenium aminodiphosphine catalyst system that incorporates a co-ligand with desirable steric and electronic characteristic, we first investigated the nature of the parent RuX₂(PNHP) compounds as well as the active catalytic species generated in the presence of a base and hydrogen gas or a hydrogen donor solvent. We discovered that some compounds of the type RuCl₂(PNHP) may crystallize as dimers, containing 2 bridging chloride ligands between the ruthenium atoms, and with the pendant chloride ligand on each ruthenium atom hydrogen bonded to the NH moiety of the aminodiphosphine ligand of the neighboring ruthenium atom.

Activation of the ruthenium aminodiphosphine compounds RuCl₂(PNHP) in the presence of a base and hydrogen gas or a hydrogen donor solvent resulted in ruthenium tetrahydride compounds of the type RuH₄(PNHP) as the active catalyst species. However, these compounds are unstable in the absence of hydrogen gas or a hydrogen donor solvent and eventually loses hydrogen to form ruthenium dihydride compounds of the type RuH₂(PNHP), which then dimerizes. The dimer contains 2 bridging hydride ligands between the ruthenium atoms, with the pendant hydride ligand on each ruthenium atom hydrogen bonded to the NH moiety of the aminodiphosphine ligand of the neighboring ruthenium atom.

Based on these discoveries that provide insight of the catalyst precursor and active catalyst species, we hypothesized that in order to develop desirable and effective ruthenium and other transition metal aminodiphosphine catalysts it will be necessary to incorporate a co-ligand that is nucleophilic and of low steric bulk. The co-ligand will prevent dimerization of both the catalyst precursor and the active catalytic species that is generated during the catalytic reaction. A nucleophilic co-ligand will prevent substitution and displacement by the substrate, solvent or other compounds in the catalytic mixture and will also provide electronic activation of the catalyst. Low steric bulk of the co-ligand will prevent it from inhibiting the catalytic process by congestion.

For applications in industry, a metal catalyst must exhibit high activity and selectivity for the desired transformation of a particular substrate. It is also equally important that the catalyst can be prepared efficiently by an optimized synthetic route that is also amenable to scale-up. Although a very large number of catalysts have been prepared in research quantities, only relatively few have been used commercially. Hence, synthetic accessibility is also an important factor for desirable transition metal aminodiphosphine catalysts.

### SUMMARY OF THE DISCLOSURE

As a result of comprehensive studies that were done, it was discovered that transition metal isonitrile compounds containing an aminodiphosphine ligand are desirable and effective catalysts for a variety of reactions, including high activity for the hydrogenation and transfer hydrogenation of carbon-carbon, carbon-oxygen and carbon-nitrogen double bonds. The isonitrile ligand is a stable and tunable co-ligand that facilitates enhanced activity of the metal catalysts, while limiting steric congestion and preventing dimerization. Without being bound by theory, the isonitrile ligand is very nucleophilic and binds strongly to the metal atom. Hence, it is not readily substituted by other ligands, the substrate or species in the reaction mixture. The isonitrile ligand binds to the metal by the electron rich carbon atom, and based on the linear structure of the isonitrile ligand, the R substituent of the isonitrile ligand is distally removed from the active site of the activated catalytic species and, as such, has little or no steric influence on the catalyst.

Accordingly, the present disclosure relates to transition metal isonitrile compounds of the Formula (I):

[MX₂(PNHP)Y] (I)

wherein, M represents iron, ruthenium or osmium, X represent, simultaneously or independently, any anionic ligand, including but not limited to hydride, halide, alkoxide, aryloxide, hydroxide, borohydride, carboxylate, among others; and the ligand Y represent an isonitrile ligand of the Formula (II):

R¹—N≡C (II)

in which R¹ represents a hydrogen atom, a linear or branched alkyl group of any length, possibly substituted, or an alkenyl group of any length, possibly substituted, or an alkynyl group, possibly substituted, or a cycloalkyl group, possibly substituted, or an aryl group, possibly substituted, or an heteroaryl group, possibly substituted, with possible and non-limiting substituents of R¹ being halogen atoms, OR^{c}, NR^{c}₂ or R_{c} groups, in which R_{c} is a hydrogen atom or a cyclic, linear or branched alkyl, aryl or alkenyl group;
and the ligand (PNHP) represents a tridentate aminodiphosphine ligand of Formula (III):

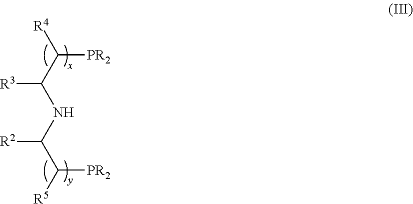

in which the R² to R⁵ symbols, taken separately, represent simultaneously or independently a hydrogen atom, a linear or branched alkyl group of any length, possibly substituted, or an alkenyl group of any length, possibly substituted, or an alkynyl group, possibly substituted, or a cycloalkyl group, possibly substituted, or an aryl group, possibly substituted, or an heteroaryl group, possibly substituted, or two adjacent or geminal groups being bonded together to form a ring including the carbon atom to which said groups are bonded;
indices x and y are, simultaneously or independently, equal to 0, 1, 2, 3 or 4;
and the R groups represent simultaneously or independently a hydrogen atom, a linear or branched alkyl, aryl or alkenyl group of any length, or an OR or NR₂ group; or the R groups on the same P atom may be bonded together to form a ring having 4 or more atoms and including the phosphorous atom to which said R groups are bonded; with possible and non-limiting substituents of R, R², R³, R⁴ and R⁵ being halogen atoms, OR^{c}, NR^{c}₂ or R^{c} groups, in which R^{c} is a hydrogen atom or a cyclic, linear or branched alkyl, aryl or alkenyl group.

The processes of the invention are particularly attractive when the aminodiphosphine ligand (PNHP) of formula (II) is chiral. Whenever (PNHP) is chiral, the process of the invention can be useful in asymmetric catalysis.

In a general way, the complexes of formula (I) can be prepared and isolated prior to their use in the catalytic process according to the general methods described in the literature. Moreover, the complexes can be prepared in situ, by several methods, in the reaction medium, without isolation or purification, just before their use.

The transformations to which the compounds of the disclosure can be applied include but are not limited to: hydrogenation, transfer hydrogenation, hydroformylation, hydrosilylation, hydroboration, hydroamination, hydrovinylation, hydroarylation, hydration, oxidation, epoxidation, reduction, C—C and C—X bond formation (includes things like Heck, Suzuki-Miyaura, Negishi, Buchwald-Hartwig Amination, α-Ketone Arylation, N-Aryl Amination, Murahashi, Kumada, Negishi and Stille reactions etc.), functional group interconversion, kinetic resolution, dynamic kinetic resolution, cycloaddition, Diels-Alder reactions, retro-Diels-Alder reactions, sigmatropic rearrangements, electrocyclic reactions, ring-opening, ring-closing, olefin metathesis, carbonylation, isotope exchange, dehydrocoupling, solvolysis and aziridination. In all transformations listed above the reactions may or may not be regioselective, chemoselective, stereoselective or diastereoselective.

Other features and advantages of the present disclosure will become apparent from the following detailed description. It should be understood, however, that the detailed description and the specific examples while indicating preferred embodiments of the disclosure are given by way of illustration only, since various changes and modifications within the spirit and scope of the disclosure will become apparent to those skilled in the art from this detailed description.

### BRIEF DESCRIPTION OF THE DRAWINGS

The invention will be described in greater detail with reference to the following drawings in which:

FIG. 1 shows the X-ray crystal structure of the ruthenium complex RuCl₂[(^{t}Bu₂PCH₂CH₂)₂NH](MeO-Ph-NC).

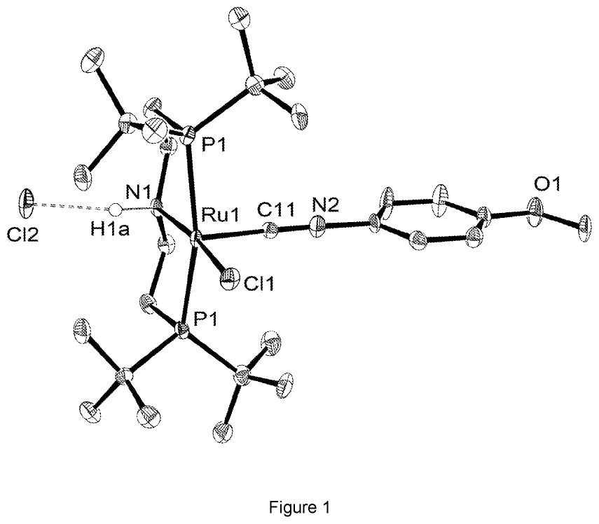

FIG. 2 shows the plot of hydrogen generation versus time for the catalytic solvolysis of ammonia borane in a mixture of 2-propanol/water using RuCl₂[(^{t}Bu₂PCH₂CH₂)₂NH](MeO-Ph-NC) as catalyst.

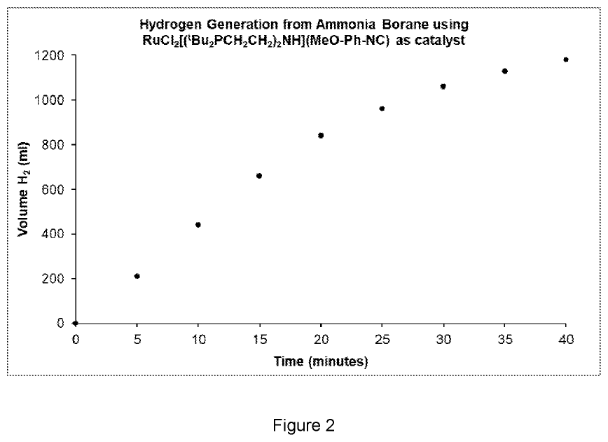

### DETAILED DESCRIPTION OF THE DISCLOSURE

### (I) Definitions

The term “alkyl” as used herein means straight and/or branched chain, saturated alkyl radicals containing one or more carbon atoms and includes (depending on the identity) methyl, ethyl, propyl, isopropyl, n-butyl, s-butyl, isobutyl, t-butyl, 2,2-dimethylbutyl, n-pentyl, 2-methylpentyl, 3-methylpentyl, 4-methylpentyl, n-hexyl and the like.

The term “alkenyl” as used herein means straight and/or branched chain, unsaturated alkyl radicals containing two or more carbon atoms and one to three double bonds, and includes (depending on the identity) vinyl, allyl, 2-methylprop-1-enyl, but-1-enyl, but-2-enyl, but-3-enyl, 2-methylbut-1-enyl, 2-methylpent-1-enyl, 4-methylpent-1-enyl, 4-methylpent-2-enyl, 2-methylpent-2-enyl, 4-methylpenta-1,3-dienyl, hexen-1-yl and the like.

The term “alkynyl” as used herein means straight and/or branched chain, unsaturated alkyl radicals containing two or more carbon atoms and one to three triple bonds, and includes (depending on the identity) acetylynyl, propynyl, but-1-ynyl, but-2-ynyl, but-3-ynyl, 3-methylbut-1-enyl, 3-methylpent-1-ynyl, 4-methylpent-1-ynyl, 4-methylpent-2-ynyl, penta-1,3-di-ynyl, hexyn-1-yl and the like.

The term “alkoxy” as used herein means straight and/or branched chain alkoxy group containing one or more carbon atoms and includes (depending on the identity) methoxy, ethoxy, propyloxy, isopropyloxy, t-butoxy, heptoxy, and the like.

The term “cycloalkyl” as used herein means a monocyclic, bicyclic or tricyclic saturated carbocylic group containing three or more carbon atoms and includes (depending on the identity) cyclopropyl, cyclobutyl, cyclopentyl, cyclodecyl and the like.

The term “aryl” as used herein means a monocyclic, bicyclic or tricyclic aromatic ring system containing at least one aromatic ring and 6 or more carbon atoms and includes phenyl, naphthyl, anthracenyl, 1,2-dihydronaphthyl, 1,2,3,4-tetrahydronaphthyl, fluorenyl, indanyl, indenyl and the like.

The term “heteroaryl” as used herein means a monocyclic, bicyclic or tricyclic ring system containing one or two aromatic rings and 5 or more atoms of which, unless otherwise specified, one, two, three, four or five are heteromoieties independently selected from N, NH, N(alkyl), O and S and includes thienyl, furyl, pyrrolyl, pyrididyl, indolyl, quinolyl, isoquinolyl, tetrahydroquinolyl, benzofuryl, benzothienyl and the like.

The term “halo” as used herein means halogen and includes chloro, fluoro, bromo or iodo.

The term “fluoro-substituted” as used herein means that at least one, including all, of the hydrogens on the referenced group is replaced with fluorine.

The suffix “ene” added on to any of the above groups means that the group is divalent, i.e. inserted between two other groups.

The term “ring system” as used herein refers to a carbon-containing ring system, that includes monocycles, fused bicyclic and polycyclic rings, bridged rings and metalocenes. Where specified, the carbons in the rings may be substituted or replaced with heteroatoms.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

### (II) Compounds of the Disclosure

The present disclosure relates to ruthenium isonitrile compounds which are useful in metal catalysis. Accordingly, in an embodiment of the disclosure, there is provided a compound of the Formula (I):

[MX₂(PNHP)Y] (I)

wherein, M represents iron, ruthenium or osmium;
X represent, simultaneously or independently, any anionic ligand, including but not limited to hydride, halide, alkoxide, aryloxide, hydroxide, borohydride, carboxylate, among others;
and the ligand Y represent an isonitrile ligand of the Formula (II):

R¹—N≡C (II)

in which R¹ represents a hydrogen atom, a linear or branched alkyl group of any length, possibly substituted, or an alkenyl group of any length, possibly substituted, or an alkynyl group, possibly substituted, or a cycloalkyl group, possibly substituted, or an aryl group, possibly substituted, or an heteroaryl group, possibly substituted, with possible and non-limiting substituents of R¹ being halogen atoms, OR^{c}, NR^{c}₂ or R^{c} groups, in which R^{c} is a hydrogen atom or a cyclic, linear or branched alkyl, aryl or alkenyl group;
and the ligand (PNHP) represents a tridentate aminodiphosphine ligand of Formula (III):

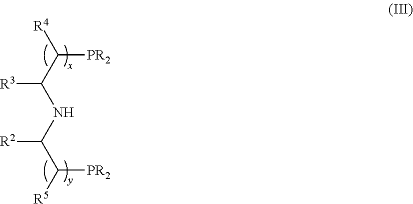

in which R² to R⁵ represent simultaneously or independently represent a hydrogen atom, a linear or branched alkyl group of any length, possibly substituted, or an alkenyl group of any length, possibly substituted, or an alkynyl group, possibly substituted, or a cycloalkyl group, possibly substituted, or an aryl group, possibly substituted, or an heteroaryl group, possibly substituted, or two adjacent or geminal groups being bonded together to form a ring including the carbon atom to which said groups are bonded;
indices x and y are, simultaneously or independently, equal to 0, 1, 2, 3 or 4;
and the R groups represent simultaneously or independently a hydrogen atom, a linear or branched alkyl, aryl, or alkenyl group of any length, or an OR or NR₂ group; or the R groups on the same P atom may be bonded together to form a ring having 4 or more atoms and including the phosphorous atom to which said R groups are bonded; with possible and non-limiting substituents of R, R², R³, R⁴ and R⁵ being halogen atoms, OR^{c}, NR^{c}₂ or R^{c} groups, in which R^{c} is a hydrogen atom or a cyclic, linear or branched alkyl, aryl or alkenyl group.

In an embodiment of the disclosure, the compound of the Formula (I) may be neutral, monocationic or dicationic.

### (III) Processes of the Disclosure

The present disclosure also relates to a process for the production of compounds of the Formula (I) comprising contacting a compound of Formula (III) and a compound of Formula (II), simultaneously or independently, with a suitable ruthenium precursor compound. Suitable metal precursor compounds include but are not limited to: MX₂, MX₂.xH₂O, MX₃.xH₂O, MX₂(DMSO)₄, [MX₂(cod)]n, MX₂(nbd)]n, [MX₂(benzene)]₂, [MX₂(p-cymene)]₂, [MX₂(mesitylene)]₂, MX₂(PPh₃)₃, MX₄(PPh₃)₃, MX₂(L)(PPh₃)₃; wherein X represent, simultaneously or independently, any anionic ligand, including but not limited to hydride, halide, alkoxide, aryloxide, hydroxide, borohydride, carboxylate, among others; and L represents any neutral ligand, including but not limited to olefin, phosphine, carbon monoxide, amine, pyridine, among others.

The disclosure also relates to a process for the production of a compound of Formula (I) by contacting a compound of Formula (II) with a metal monomeric compound of formula MX₂(PNHP) or a metal dimeric compound of formula [MX₂(PNHP)]₂, wherein X represent, simultaneously or independently, any anionic ligand, including but not limited to hydride, halide, alkoxide, aryloxide, hydroxide, borohydride, carboxylate, among others.

In an embodiment of the disclosure, the ruthenium isonitrile compounds of Formula (I) are isolated or alternatively, are generated in situ.

In an embodiment of the invention, the catalytic reactions of metal isonitrile compounds of Formula (I) include, but are not limited to hydrogenation, transfer hydrogenation, hydroformylation, hydrosilylation, hydroboration, hydroamination, hydrovinylation, hydroarylation, hydration, isomerizations, oxidation, epoxidation, C—C bond formation, C—X bond formation, functional group interconversion, kinetic resolution, dynamic kinetic resolution, cycloaddition, Diels-Alder reaction, retro-Diels-Alder reaction, sigmatropic rearrangement, electrocyclic reaction, olefin metathesis, polymerization, carbonylation, isotope exchange, dehydrocoupling, solvolysis and aziridination.

In an embodiment, the metal complexes of the present disclosure are used as catalysts for asymmetric hydrogenation and transfer hydrogenation. In a further embodiment, the asymmetric hydrogenation or transfer hydrogenation comprises the hydrogenation of a substrate possessing at least one C═C, C═N and/or C═O bond. In another embodiment, the substrate containing the at least one C═C, C═N and/or C═O bond is prochiral, and the hydrogenated product is chiral and enantiomerically enriched with an enantiomeric excess of at least 50%, optionally 80% or 90%.

In an embodiment of the invention, compounds of Formula (I) are use as catalysts for the hydrogenation and transfer hydrogenation of compounds containing a carbon-carbon (C═C) double bond, or a carbon-oxygen (C═O) double bond, or a carbon-nitrogen (C═N) double bond to the corresponding hydrogenated products.

In the process of the invention, there can be reduced substrates of Formula:

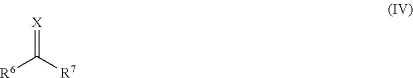

wherein, X represents CR⁸R⁹, NR¹⁰ or O, and R⁶ to R¹⁰ each independently or simultaneously represents a hydrogen atom, a hydroxy radical, an alkoxy or aryloxy group, a cyclic, linear or branched alkyl or alkenyl group of any length, possibly substituted, or an aromatic ring, possibly substituted, or one or more of R⁶ to R¹⁰ optionally being linked in such a way as to form a ring or rings, possibly substituted;

to provide the corresponding hydrogenated compounds of Formula (V):

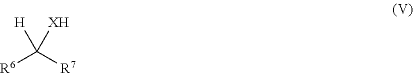

wherein X, R⁶ and R⁷ are defined as in formula (IV). Possible substituents of R⁶ to R⁷ being halogen atoms, OR^{c}, NR^{c}₂ or R^{c} groups, in which R^{c} is a hydrogen atom or a cyclic, linear or branched alkyl, aryl or alkenyl group. Optionally, one or more of the carbon atoms in R⁶ to R⁷ may be substituted with a heteroatom, such as O, S, N, P or Si, which in turn may bear one or more substituents.

Since R⁶ and R⁷ may be different, it is hereby understood that the final product, of formula (V), may be chiral, thus possibly consisting of a practically pure enantiomer or of a mixture of stereoisomers, depending on the nature of the catalyst used in the process.

In another embodiment of the invention, there can be reduced substrates of Formula (VI):

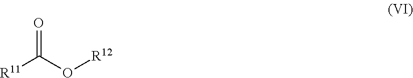

wherein, R¹¹ to R¹² each independently or simultaneously represents a hydrogen atom, a cyclic, linear or branched alkyl or alkenyl group of any length, possibly substituted, or an aromatic ring, possibly substituted, or one or more of R¹¹ to R¹² optionally being linked in such a way as to form a ring or rings, possibly substituted to provide the corresponding hydrogenated compounds of Formula (VII) and Formula (VIII):

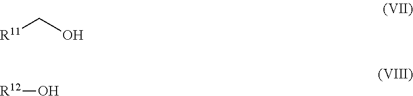

wherein R¹¹ and R¹² are defined as in Formula (VI). Possible substituents of R¹¹ to R¹² being halogen atoms, OR^{c}, NR^{c}₂ or R^{c} groups, in which R^{c} is a hydrogen atom or a cyclic, linear or branched alkyl, aryl or alkenyl group. Optionally, one or more of the carbon atoms in R¹¹ to R¹² may be substituted with a heteroatom, such as O, S, N, P or Si, which in turn may bear one or more substituents.

In another embodiment of the invention, there can be reduced substrates of Formula (IX):

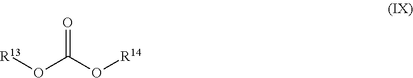

wherein, R¹³ to R¹⁴ each independently or simultaneously represents a hydrogen atom, a cyclic, linear or branched alkyl or alkenyl group of any length, possibly substituted, or an aromatic ring, possibly substituted, or one or more of R¹³ to R¹⁴ optionally being linked in such a way as to form a ring or rings, possibly substituted to provide the corresponding hydrogenated compounds of Formula (X), Formula (XI) and methanol (Formula (XII)):

R¹³—OH (X)

R¹⁴—OH (XI)

H₃C—OH (XII)

wherein R¹³ and R¹⁴ are defined as in formula (IX). Possible substituents of R¹³ to R¹⁴ being halogen atoms, OR^{c}, NR^{c}₂ or R^{c} groups, in which R^{c} is a hydrogen atom or a cyclic, linear or branched alkyl, aryl or alkenyl group. Optionally, one or more of the carbon atoms in R¹³ to R¹⁴ may be substituted with a heteroatom, such as O, S, N, P or Si, which in turn may bear one or more substituents. Reduction of compounds of Formula (IX) using a catalyst of Formula (I) in the presence of deuterium gas or transfer hydrogenation using a deuterated solvent provides a means of producing deuterated methanol (CD₃OD).

In another embodiment of the invention, there can be reduced substrates of formula:

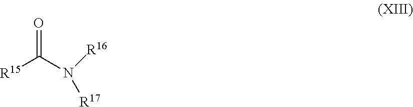

wherein, R¹⁵ to R¹⁷ each independently or simultaneously represents a hydrogen atom, a cyclic, linear or branched alkyl or alkenyl group of any length, possibly substituted, or an aromatic ring, possibly substituted, or one or more of R¹⁵ to R¹⁷ optionally being linked in such a way as to form a ring or rings, possibly substituted to provide the corresponding hydrogenated compounds of Formula (XIV) and Formula (XV):

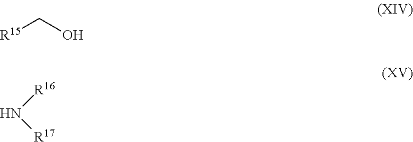

wherein R¹⁵ to R¹⁷ are defined as in Formula (XIII). Possible substituents of R¹⁵ to R¹⁷ being halogen atoms, OR^{c}, NR^{c}₂ or R^{c} groups, in which R^{c} is a hydrogen atom or a cyclic, linear or branched alkyl, aryl or alkenyl group. Optionally, one or more of the carbon atoms in R¹⁵ to R¹⁷ may be substituted with a heteroatom, such as O, S, N, P or Si, which in turn may bear one or more substituents.

Another embodiment of the disclosure includes a method for the production of hydrogen comprising:

(a) contacting a solution comprising a compound of Formula (I) with at least one amine-borane compound of Formula (XVI),

R¹⁸R¹⁹HNBHR²⁰R²¹ (XVI),

in a solvent under conditions for the solvolysis or dehydrocoupling of the compound of Formula (XVI),
wherein R¹⁸, R¹⁹, R²⁰ and R²¹ are each simultaneously or independently selected from H, branched or unbranched fluoro-substituted-C₁₋₂₀ alkyl, branched or unbranched C₁₋₂₀ alkyl and C₆₋₁₄aryl or any two of R¹⁸, R¹⁹, R²⁰ and R²¹ are linked to form a branched or unbranched C₂₋₁₀alkylene, which together with the nitrogen and/or boron atoms to which they are attached, forms a ring, and
(b) optionally collecting hydrogen produced in the solvolysis or dehydrocoupling of the compounds of Formula (XVI).

In an embodiment of the invention, the catalytic system characterizing the process of the instant invention may comprise a base. Said base can be the substrate itself, if the latter is basic, or any conventional base. One can cite, as non-limiting examples, organic non-coordinating bases such as DBU, an alkaline or alkaline-earth metal carbonate, a carboxylate salt such as sodium or potassium acetate, or an alcoholate or hydroxide salt. Preferred bases are the alcoholate or hydroxide salts selected from the group consisting of the compounds of formula (R¹⁸O)₂M′ and R¹⁸O M″, wherein M′ is an alkaline-earth metal, M″ is an alkaline metal and R¹⁸ stands for hydrogen or a linear or branched alkyl group.

A typical hydrogenation or transfer hydrogenation process implies the mixture of the substrate with a metal isonitrile compound of Formula (I) with or without a base, possibly in the presence of a solvent, and then treating such a mixture with hydrogen or a hydrogen donor solvent at a chosen pressure and temperature.

The compound of Formula (I) can be added to the reaction medium in a large range of concentrations. As non-limiting examples, one can cite as complex concentration values those ranging from 0.1 ppm to 50,000 ppm, relative to the amount of substrate, thus representing respectively a substrate/complex (S/com) ratio of 10⁷ to 20. Preferably, the complex concentration will be comprised between 0.1 and 1000 ppm, i.e. a S/com ratio of 10⁷ to 1000 respectively. More preferably, there will be used concentrations in the range of 0.5 to 100 ppm, corresponding to a S/com ratio of 10,000 to 2×10⁶ respectively.

If required, useful quantities of base, added to the reaction mixture, may be comprised in a relatively large range. One can cite, as non-limiting examples, ranges between 1 to 50,000 molar equivalents relative to the complex (e.g. base/com=0.5 to 50,000), or 100 to 20,000, or even between 400 and 10,000 molar equivalents. However, it should be noted that it is also possible to add a small amount of base (e.g. base/com=1 to 3) to achieve high yields.

In the processes of this invention, the hydrogenation and transfer hydrogenation reaction can be carried out in the presence or absence of a solvent. When a solvent is required or used for practical reasons, then any solvent current in transfer hydrogenation reactions can be used for the purposes of the invention. Non-limiting examples include aromatic solvents such as benzene, toluene or xylene, hydrocarbon solvents such as hexane or cyclohexane, ethers such as tetrahydrofuran, or yet primary or secondary alcohols, or mixtures thereof. A person skilled in the art is well able to select the solvent most convenient in each case to optimize the hydrogenation and transfer hydrogenation reaction.

Hydrogen donors include primary and secondary alcohols, primary and secondary amines, carboxylic acids and their esters and amine salts, readily dehydrogenatable hydrocarbons, amine boranes, clean reducing agents, and any combination thereof.

Primary and secondary alcohols may be employed as hydrogen donors. Examples of primary and secondary alcohols that may be represented as hydrogen donors include methanol, ethanol, propan-1-ol, propan-2-ol, butan-1-ol, butan-2-ol, cyclopentanol, cyclohexanol, benzylalcohol, and menthol. When the hydrogen donor is an alcohol, secondary alcohols are preferred, especially propan-2-ol, and butan-2-ol.

Primary and secondary amines may be employed as hydrogen donors. Examples of primary and secondary amines, which may be represented as hydrogen donors, include ethylamine, propylamine, isopropylamine, butylamine, isobutylamine, hexylamine, diethylamine, dipropylamine, di-isopropylamine, dibutylamine, di-isobutylamine, dihexylamine, benzylamine, dibenzylamine and piperidine. When the hydrogen donor is an amine, primary amines are preferred, especially primary amines comprising a secondary alkyl group, particularly isopropylamine and isobutylamine.

Carboxylic acids or their esters may be employed as hydrogen donors. Examples of carboxylic acids, which may be employed as hydrogen donors include formic acid, lactic acid, ascorbic acid and mandelic acid. When a carboxylic acid is employed as hydrogen donor, at least some of the carboxylic acid is preferably present as an amine salt or ammonium salt. Amines, which may be used to form such salts, include both aromatic and non-aromatic amines, also primary, secondary and tertiary amines. Tertiary amines, especially trialkylamines, are preferred. Examples of amines, which may be used to form salts, include trimethylamine, triethylamine, di-isopropylethylamine and pyridine. The most preferred amine is triethylamine. When at least some of the carboxylic acid is present as an amine salt, particularly when a mixture of formic acid and triethylamine is employed, the mole ratio of acid to amine is commonly about 5:2. This ratio may be maintained during the course of the reaction by the addition of either component, but usually by the addition of the carboxylic acid.

Readily dehydrogenatable hydrocarbons, which may be employed as hydrogen donors, comprise hydrocarbons, which have a propensity to aromatise or hydrocarbons, which have a propensity to form highly conjugated systems. Examples of readily dehydrogenatable hydrocarbons, which may be employed as hydrogen donors, include cyclohexadiene, cyclohexane, tetralin, dihydrofuran and terpenes.

The most preferred hydrogen donors are propan-2-ol, butan-2-ol, triethylammonium formate and a mixture of triethlammonium formate and formic acid.

The temperature at which the transfer hydrogenation can be carried out is comprised between 0° C. and 200° C., more preferably in the range of between 20° C. and 100° C. Of course, a person skilled in the art is also able to select the preferred temperature as a function of the melting and boiling point of the starting and final products.

Standard hydrogenation conditions, as used herein, typically implies the mixture of the substrate with a metal complex of Formula (I) with or without a base, possibly in the presence of a solvent, and then treating such a mixture with a hydrogen donor solvent at a chosen pressure and temperature (transfer hydrogenation) or in an atmosphere of hydrogen gas at a chosen pressure and temperature. Varying the reaction conditions, including for example, temperature, pressure, solvent and reagent ratios, to optimize the yield of the desired product would be well within the abilities of a person skilled in the art.

### (IV) Examples

The disclosure will now be described in further details by way of the following examples, wherein the temperatures are indicated in degrees centigrade and the abbreviations have the usual meaning in the art. All the procedures described hereafter have been carried out under an inert atmosphere unless stated otherwise. All preparations and manipulations were carried out under H₂, N₂ or Ar atmospheres with the use of standard Schlenk, vacuum line and glove box techniques in dry, oxygen-free solvents. Deuterated solvents were degassed and dried over activated molecular sieves. NMR spectra were recorded on a 300 MHz spectrometer (300 MHz for ¹H, 75 MHz for ¹³C and 121.5 MHz for ³¹P) or a 400 MHz spectrometer (400 MHz for ¹H, 100 MHz for ¹³C and 162 MHz for ³¹P). All ³¹P chemical shifts were measured relative to 85% H₃PO₄ as an external reference. ¹H and ¹³C chemical shifts were measured relative to partially deuterated solvent peaks but are reported relative to tetramethylsilane.

### Example 1. Preparation of (Ph₂PCH₂CH₂)₂NH.HCl

Chlorodiphenylphosphine (15 g, 68 mmol) was added in 2 g portions to a vigorously stirred suspension of lithium granules (1.5 g, 0.22 mol) in THF (30 ml) at 0° C. and the mixture stirred for 3 days at room temperature. The mixture was cooled to 0° C. and a solution of bis(chloroethyl)trimethylsilylamine (8.5 g, 35 mmol) in THF (10 ml) was slowly added. The resulting suspension was then allowed to slowly warm to room temperature and refluxed for one hour. After cooling to room temperature, water (15 ml) was added and the mixture stirred for one hour. The aqueous layer was removed and another portion of water (15 ml) and hexanes (15 ml) added. The biphasic mixture was refluxed for 4 hours then cooled to room temperature. The aqueous layer was removed and the mixture evaporated to give the crude product. A 2M solution of aqueous HCl (200 ml) was added with vigorous stirring, resulting in the formation of the ammonium chloride salt as a white solid. This was filtered, washed with water, cold methanol and hexanes, then dried under vacuum. Yield=13.8 g.

### Example 2. Preparation of (ⁱPr₂PCH₂CH₂)₂NH

Chlorodiisopropylphosphine (25.2 g, 165 mmol) was added in 2 ml portions to a suspension of lithium granules (3.6 g, 519 mmol) in THF (100 ml) at 0° C. After the addition was completed, the mixture was stirred at room temperature for 3 days. The mixture was filtered and N-trimethylsilylbis(chloroethyl)amine (17.67 g, 82.5 mmol) was slowly added at 0° C. The mixture was stirred at room temperature for 1 hour; then refluxed for 2 hours under argon. The mixture was cooled to room temperature and water (50 ml) added and the mixture stirred for 1 hour. The aqueous layer was removed and another 50 ml of water was added along with 50 ml of hexanes. The mixture was refluxed for 4 hours. It was cooled to room temperature and the aqueous layer was removed. The mixture was then evaporated to yield the crude product, which was purified by vacuum distillation. Yield=21.2 g.

### Example 3. Preparation of (^{t}Bu₂PCH₂CH₂)₂NH

Chlorodi-tert-butylphosphine (25.7 g, 142 mmol) was added in 2 ml portions to a suspension of lithium granules (3.35 g, 483 mmol) in THF (100 ml) at 0° C. After the addition was completed, the mixture was stirred at room temperature for 3 days. The mixture was filtered and N-trimethylsilylbis(chloroethyl)amine (15.2 g, 71 mmol) in THF (20 ml) was slowly added at 0° C. The mixture was stirred at room temperature for 1 hour; then refluxed for 2 hours under argon. The mixture was cooled to room temperature and water (25 ml) added and the mixture stirred for 1 hour. The aqueous layer was removed and another 25 ml of water was added along with 25 ml of hexanes. The mixture was refluxed for 4 hours. It was cooled to room temperature and the aqueous layer was removed. The mixture was then evaporated to yield the crude product, which was purified by vacuum distillation. Yield=22.2 g.

### Example 4. Preparation of (Cy₂PCH₂CH₂)₂NH

To a solution of dicyclohexylphosphine (35.4 g, 178 mmol) in THF (200 ml) was added n-butyllithium (78.6 ml, 2.5 M in hexanes, 197 mmol) at 0° C. The resulting suspension was refluxed for 4 hours at 60° C. The mixture was cooled to 0° C. and a solution of N-trimethylsilylbis(chloroethyl)amine (19.1 g, 89.2 mmol) in THF (20 ml) was slowly added at 0° C. The mixture was stirred at room temperature for 1 hour; then refluxed for 6 hours under argon. The mixture was cooled to room temperature and water (35 ml) added and the mixture stirred for 1 hour. The aqueous layer was removed and H₂SO₄ (25 ml of a 0.4 M solution) was added. The mixture was refluxed for 4 hours then cooled to room temperature. NaOH (25 ml of a 1.0 M solution) was then added and the mixture stirred for 1 hour then the aqueous layer was removed. The organic layer was washed with water (2×25 ml) then dried (Na₂SO₄) and evaporated to dryness to yield the product which was isolated as a viscous oil which crystallized after 3 days. Yield=34.98 g.

### Example 5. Preparation of (Ad₂PCH₂CH₂)₂NH

To a solution of di-1-adamantylphosphine (5.38 g, 17.8 mmol) in THF (20 ml) was added n-butyllithium (7.9 ml, 2.5 M in hexanes, 19.7 mmol) at 0° C. The resulting suspension was refluxed for 4 hours at 60° C. The mixture was cooled to 0° C. and a solution of N-trimethylsilylbis(chloroethyl)amine (1.91 g, 8.9 mmol) in THF (5 ml) was slowly added at 0° C. The mixture was stirred at room temperature for 1 hour; then refluxed for 6 hours under argon. The mixture was cooled to room temperature and water (10 ml) added and the mixture stirred for 1 hour. The aqueous layer was removed and H₂SO₄ (2.5 ml of a 0.4 M solution) was added. The mixture was refluxed for 4 hours then cooled to room temperature. NaOH (2.5 ml of a 1.0 M solution) was then added and the mixture stirred for 1 hour then the aqueous layer was removed. The organic layer was washed with water (2×10 ml) then dried (Na₂SO₄) and evaporated to dryness to yield the product as a pale yellow solid. Yield=4.8 g.

### Example 6. Preparation of RuCl₂[(Ph₂PCH₂CH₂)₂NH]

2-Propanol (3 ml) was added to a mixture of [RuCl₂(benzene)]₂ (250 mg, 0.50 mmol), triethylamine (200 mg) and (Ph₂PCH₂CH₂)₂NH.HCl (480 mg, 1.00 mmol) and the mixture refluxed for 4 hours. The mixture was cooled to room temperature and the yellow solid was filtered and washed with 2-propanol and dried under vacuum. Yield=372 mg.

### Example 7. Preparation of RuCl₂[(ⁱPr₂PCH₂CH₂)₂NH)]

2-Propanol (10 ml) was added to a mixture of [RuCl₂(benzene)]₂ (250 mg, 0.50 mmol) and (ⁱPr₂PCH₂CH₂)₂NH (310 mg, 1.01 mmol) and the mixture refluxed for 18 hours. The mixture was cooled to room temperature and the yellow solid was filtered and washed with 2-propanol, then ether and dried under vacuum. Yield=298 mg.

### Example 8. Preparation of RuH₄[(ⁱPr₂PCH₂CH₂)₂NH]

2-Propanol (2 ml) was added to a mixture of [RuCl₂((ⁱPr₂PCH₂CH₂)₂NH)]₂ (200 mg, 0.21 mmol) and KOtBu (141 mg, 1.25 mmol) and the mixture stirred for 6 hours under hydrogen gas at 60° C. The mixture was cooled to room temperature, filtered and hexanes (10 ml) added. The tan colored solid was filtered, washed with hexanes and dried under vacuum. Yield=152 mg.

### Example 9. Preparation of [RuH₂((ⁱPr₂PCH₂CH₂)₂NH)]₂

Hexanes (5 ml) was added to RuH₄((ⁱPr₂PCH₂CH₂)₂NH) (50 mg, 0.12 mmol) and the suspension was refluxed for 18 hours. It was slowly cooled to room temperature and the red crystals were filtered and dried under vacuum. Yield=42 mg.

### Example 10. Preparation of RuCl₂[(^{t}Bu₂PCH₂CH₂)₂NH]

2-Propanol (10 ml) was added to a mixture of [RuCl₂(benzene)]₂ (250 mg, 0.50 mmol) and (^{t}Bu₂PCH₂CH₂)₂NH (362 mg, 1.00 mmol) and the mixture refluxed for 18 hours. The mixture was cooled to room temperature and the yellow solid was filtered and washed with 2-propanol, then ether and dried under vacuum. Yield=320 mg.

### Example 11. Preparation of RuCl₂[(Cy₂PCH₂CH₂)₂NH]

2-Propanol (10 ml) was added to a mixture of [RuCl₂(benzene)]₂ (250 mg, 0.50 mmol) and (Cy₂PCH₂CH₂)₂NH (466 mg, 1.00 mmol) and the mixture refluxed for 18 hours. The mixture was cooled to room temperature and the yellow solid was filtered and washed with 2-propanol, then ether and dried under vacuum. Yield=405 mg.

### Example 12. Preparation of RuCl₂[(Ad₂PCH₂CH₂)₂NH]

2-Propanol (10 ml) was added to a mixture of [RuCl₂(benzene)]₂ (250 mg, 0.50 mmol) and (Ad₂PCH₂CH₂)₂NH (675 mg, 1.00 mmol) and the mixture refluxed for 18 hours. The mixture was cooled to room temperature and the yellow solid was filtered and washed with 2-propanol, then ether and dried under vacuum. Yield=602 mg.

### Example 13. Preparation of RuCl₂[(Ph₂PCH₂CH₂)₂NH](t-Bu-NC)

A solution of t-butyl isonitrile (135 mg, 1.63 mmol) in toluene (5 ml) was added to RuCl₂((Ph₂PCH₂CH₂)₂NH) (1.0 g, 1.62 mmol) and the resulting suspension refluxed for 15 hours under argon. It was cooled to room temperature and hexanes (20 ml) added. The pale yellow solid was filtered, washed with hexanes and dried under vacuum. Yield=0.82 g.

### Example 14. Preparation of RuCl₂[(Ph₂PCH₂CH₂)₂NH](Ph-NC)

A solution of phenyl isonitrile (168 mg, 1.63 mmol) in toluene (5 ml) was added to RuCl₂((Ph₂PCH₂CH₂)₂NH) (1.0 g, 1.62 mmol) and the resulting suspension refluxed for 15 hours under argon. It was cooled to room temperature and hexanes (20 ml) added. The pale yellow solid was filtered, washed with hexanes and dried under vacuum. Yield=0.98 g.

### Example 15. Preparation of RuCl₂[(ⁱPr₂PCH₂CH₂)₂NH](t-Bu-NC)

A solution of t-butyl isonitrile (174 mg, 2.09 mmol) in toluene (5 ml) was added to RuCl₂((ⁱPr₂PCH₂CH₂)₂NH) (1.0 g, 2.08 mmol) and the resulting suspension refluxed for 15 hours under argon. It was cooled to room temperature and hexanes (20 ml) added. The pale yellow solid was filtered, washed with hexanes and dried under vacuum. Yield=0.74 g.

### Example 16. Preparation of RuH₂[(ⁱPr₂PCH₂CH₂)₂NH](t-Bu-NC)

A solution of t-butyl isonitrile (20 mg, 0.24 mmol) in toluene (1.0 ml) was added to RuH₂((ⁱPr₂PCH₂CH₂)₂NH) (100 mg, 0.24 mmol) and the resulting suspension refluxed for 15 hours under argon. It was cooled to room temperature and hexanes (5 ml) added. The off white solid was filtered, washed with hexanes and dried under vacuum. Yield=56 mg.

### Example 17. Preparation of RuCl₂[(^{t}Bu₂PCH₂CH₂)₂NH](t-Bu-NC)

A solution of t-butyl isonitrile (156 mg, 1.87 mmol) in toluene (5 ml) was added to RuCl₂((^{t}Bu₂PCH₂CH₂)₂NH) (1.0 g, 1.86 mmol) and the resulting suspension refluxed for 15 hours under argon. It was cooled to room temperature and hexanes (20 ml) added. The tan colored solid was filtered, washed with hexanes and dried under vacuum. Yield=0.86 g.

### Example 18. Preparation of RuCl₂[(Cy₂PCH₂CH₂)₂NH](t-Bu-NC)

A solution of t-butyl isonitrile (130 mg, 1.57 mmol) in toluene (5 ml) was added to RuCl₂((Cy₂PCH₂CH₂)₂NH) (1.0 g, 1.56 mmol) and the resulting suspension refluxed for 15 hours under argon. It was cooled to room temperature and hexanes (20 ml) added. The off-white solid was filtered, washed with hexanes and dried under vacuum. Yield=1.02 g.

### Example 19. Preparation of RuCl₂[(Ad₂PCH₂CH₂)₂NH](t-Bu-NC)

A solution of t-butyl isonitrile (98 mg, 1.18 mmol) in toluene (5 ml) was added to RuCl₂((Ad₂PCH₂CH₂)₂NH]₂ (1.0 g, 1.18 mmol) and the resulting suspension refluxed for 15 hours under argon. It was cooled to room temperature and hexanes (20 ml) added. The off-white solid was filtered, washed with hexanes and dried under vacuum. Yield=0.94 g.

### Example 20. Preparation of RuCl₂[(Ph₂PCH₂CH₂)₂NH](MeO-Ph-NC)

A solution of 4-methoxyphenyl isonitrile (49 mg, 0.36 mmol) in toluene (2 ml) was added to RuCl₂((Ph₂PCH₂CH₂)₂NH) (224 mg, 0.36 mmol) in toluene (10 ml) and the resulting suspension refluxed for 15 hours under argon. It was cooled to room temperature and diethyl ether (10 ml) added. The pale yellow solid was filtered, washed with hexanes and dried under vacuum. Yield=240 mg.

### Example 21. Preparation of RuCl₂[(ⁱPr₂PCH₂CH₂)₂NH](MeO-Ph-NC)

Toluene (10 ml) was added to a mixture of 4-methoxyphenyl isonitrile (139 mg, 1.05 mmol) and RuCl₂((ⁱPr₂PCH₂CH₂)₂NH) (500 mg, 1.05 mmol) and the resulting suspension refluxed for 20 hours under argon. It was cooled to room temperature and ether (20 ml) added. The pale yellow solid was filtered, washed with hexanes and dried under vacuum. Yield=0.60 g.

### Example 22. Preparation of RuCl₂[(^{t}Bu₂PCH₂CH₂)₂NH](MeO-Ph-NC)

A solution of (^{t}Bu₂PCH₂CH₂)₂NH (1.0 g, 2.77 mmol) was added to [RuCl₂(cod)]n (0.775 g, 2.77 mmol) and the resulting suspension stirred for 4 hours under argon. This was followed by the addition of 4-methoxyphenyl isonitrile (368 mg, 2.77 mmol) and the mixture refluxed for 15 hours under argon. It was cooled to room temperature and ether (40 ml) added, and the suspension stirred for 1 hour at room temperature. It was filtered, washed with ether and dried under vacuum. Yield=1.44 g. X-ray quality crystals were obtained by slow diffusion of ether into a CH₂Cl₂ solution of the compound.

### Example 23. Preparation of RuCl₂[(Cy₂PCH₂CH₂)₂NH](MeO-Ph-NC)

Toluene (10 ml) was added to a mixture of 4-methoxyphenyl isonitrile (104 mg, 0.78 mmol) and RuCl₂((Cy₂PCH₂CH₂)₂NH) (0.5 g, 0.78 mmol) and the resulting suspension refluxed for 15 hours under argon. It was cooled to room temperature and ether (40 ml) added. The off-white solid was filtered, washed with hexanes and dried under vacuum. Yield=0.32 g.

### Example 24. Preparation of RuCl₂[(Ad₂PCH₂CH₂)₂NH](MeO-Ph-NC)

Toluene (5 ml) was added to a mixture of (Ad₂PCH₂CH₂)₂NH (250 mg, 0.37 mmol) and [RuCl₂(cod)]ₙ (104 mg, 0.37 mmol) under argon and the mixture refluxed for 20 hours. The mixture was cooled to room temperature and 4-methoxyphenyl isonitrile (49 mg, 0.37 mmol) added and the mixture refluxed for 12 hours under argon. It was cooled to room temperature and ether (40 ml) added. The pale brown solid was filtered, washed with ether and dried under vacuum. Yield=0.18 g.

### Example 25. Preparation of FeCl₂[(ⁱPr₂PCH₂CH₂)₂NH]

THF (10 ml) was added to a mixture of FeCl₂ (0.206 g, 1.6 mmol) and (ⁱPr₂PCH₂CH₂)₂NH (0.50 g, 1.6 mmol) and the suspension heated at reflux for 2 hours under argon. It was cooled to room temperature and ether (20 ml) added under argon. The mixture was stirred for 1 hour, then filtered, washed with ether and dried under vacuum. Yield=0.609 g.

### Example 26. Preparation of FeCl₂[(^{t}Bu₂PCH₂CH₂)₂NH]

THF (10 ml) was added to a mixture of FeCl₂ (0.175 g, 1.38 mmol) and (^{t}Bu₂PCH₂CH₂)₂NH (0.50 g, 1.38 mmol) and the suspension heated at 60° C. for 20 hours under argon. It was cooled to room temperature and ether (20 ml) added under argon. The mixture was stirred for 1 hour, then filtered, washed with ether and dried under vacuum. Yield=0.640 g.

### Example 27. Preparation of FeCl₂[(Cy₂PCH₂CH₂)₂NH]

THF (10 ml) was added to a mixture of FeCl₂ (0.136 g, 1.07 mmol) and (Cy₂PCH₂CH₂)₂NH (0.50 g, 1.07 mmol) and the suspension heated at 60° C. for 15 hours under argon. It was cooled to room temperature and ether (20 ml) added under argon. The mixture was stirred for 1 hour, then filtered, washed with ether and dried under vacuum. Yield=0.534 g.

### Example 28. Preparation of FeCl₂[(ⁱPr₂PCH₂CH₂)₂NH](MeO-Ph-NC)

A solution of 4-methoxyphenyl isonitrile (77 mg, 0.58 mmol) in CH₂Cl₂ (10 ml) was added to a suspension of FeCl₂[(Pr₂PCH₂CH₂)₂NH] (250 mg, 0.58 mmol) and the mixture stirred at room temperature for 1 hour under argon. The mixture was concentrated to approximately 1 ml, and ether (20 ml) added under argon. The green suspension was stirred for 1 hour, then filtered, washed with ether and dried under vacuum. Yield=0.231 g.

### Example 29. Preparation of FeCl₂[(^{t}Bu₂PCH₂CH₂)₂NH](MeO-Ph-NC)

A solution of 4-methoxyphenyl isonitrile (68 mg, 0.51 mmol) in CH₂Cl₂ (10 ml) was added to a suspension of FeCl₂[(^{t}Bu₂PCH₂CH₂)₂NH] (250 mg, 0.51 mmol) and the mixture stirred at room temperature for 1 hour under argon. It was evaporated to dryness, and ether (20 ml) added under argon. The yellow-green suspension was stirred for 15 hour, then filtered, washed with ether and dried under vacuum. Yield=0.244 g.

### Example 30. Preparation of FeCl₂[(Cy₂PCH₂CH₂)₂NH](MeO-Ph-NC)

A solution of 4-methoxyphenyl isonitrile (56 mg, 0.42 mmol) in CH₂Cl₂ (10 ml) was added to a suspension of FeCl₂[(Cy₂PCH₂CH₂)₂NH] (250 mg, 0.42 mmol) and the mixture stirred at room temperature for 1 hour under argon. The mixture was concentrated to approximately 1 ml, and ether (20 ml) added under argon.

The yellow-green suspension was stirred for 1 hour, then filtered, washed with ether and dried under vacuum. Yield=0.160 g.

### Example 31. Preparation of OsCl₂[(^{t}Bu₂PCH₂CH₂)₂NH](Ph-NC)

A toluene (5 ml) solution of (^{t}Bu₂PCH₂CH₂)₂NH (180 mg, 0.50 mmol) was added to a solution of OsCl₂(PPh₃)₃ (500 mg, 0.47 mmol) in toluene (5 ml) and the mixture was stirred at 100° C. for 1 hour. It was cooled to room temperature and a solution of phenyl isonitrile (51 mg, 0.50 mmol) in toluene (5 ml) was slowly added with stirring. The mixture was then stirred at 100° C. for 8 hours. It was cooled to room temperature and concentrated to approximately 5 ml. Hexanes (20 ml) was added and the suspension was stirred for 2 hours. It was filtered and the pale yellow-green solid was filtered, washed with hexanes and dried under vacuum. Yield=216 mg.

### Example 32. Preparation of OsCl₂[(ⁱPr₂PCH₂CH₂)₂NH](PPh₃)

Toluene (10 ml) was added to a mixture of (ⁱPr₂PCH₂CH₂)₂NH (146 mg, 0.48 mmol) and OsCl₂(PPh₃)₃ (500 mg, 0.47 mmol) and the mixture was stirred at 60° C. for 1 hour. It was cooled to room temperature and concentrated to approximately 1 ml under reduced pressure. Ether (20 ml) was added and the suspension was stirred for 30 minutes. It was filtered and the red brown solids were filtered, washed with ether and dried under vacuum. Yield=0.258 g.

### Example 33. Preparation of OsCl₂[(ⁱPr₂PCH₂CH₂)₂NH](MeO-Ph-NC)

THF (10 ml) was added to a mixture of 4-methoxyphenyl isonitrile (24 mg, 0.18 mmol) and OsCl₂[(ⁱPr₂PCH₂CH₂)₂NH](PPh₃) (150 mg, 0.18 mmol) and the mixture refluxed for 1 hour under argon. It was cooled to room temperature and evaporated to dryness. Ether (20 ml) was added and the brown suspension was stirred for 1 hour, then filtered, washed with ether and dried under vacuum. Yield=0.110 g.

### Example 34. Hydrogenation of Acetophenone Using Ruthenium Isonitrile Compounds as Catalysts

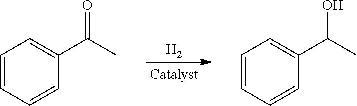

### Example 34.1. Hydrogenation of Acetophenone Using RuCl₂[(Ph₂PCH₂CH₂)₂NH](t-Bu-NC) as Catalyst

The catalyst (5 mg) is added to a mixture of acetophenone (5.6 g) and KOtBu (10 mg) in a 100 ml Parr pressure reactor. The mixture was degassed with hydrogen and the pressure was set to 10 atm. The mixture was stirred for 5 hours at 30° C. The NMR spectra of the reaction mixture showed complete conversion of the ketone to the alcohol.

### Example 34.2. Hydrogenation of Acetophenone Using RuCl₂[(Ph₂PCH₂CH₂)₂NH](Ph-NC) as Catalyst

The catalyst (5 mg) is added to a mixture of acetophenone (5.6 g) and KOtBu (10 mg) in a 100 ml Parr pressure reactor. The mixture was degassed with hydrogen and the pressure was set to 10 atm. The mixture was stirred for 5 hours at 30° C.

The NMR spectra of the reaction mixture showed complete conversion of the ketone to the alcohol.

### Example 34.3. Hydrogenation of Acetophenone Using RuCl₂[(ⁱPr₂PCH₂CH₂)₂NH](t-Bu-NC) as Catalyst

The catalyst (5 mg) is added to a mixture of acetophenone (5.6 g) and KOtBu (10 mg) in a 100 ml Parr pressure reactor. The mixture was degassed with hydrogen and the pressure was set to 10 atm. The mixture was stirred for 5 hours at 30° C. The NMR spectra of the reaction mixture showed complete conversion of the ketone to the alcohol.

### Example 34.4. Hydrogenation of Acetophenone Using RuH₂[(ⁱPr₂PCH₂CH₂)₂NH](t-Bu-NC) as Catalyst

The catalyst (5 mg) is added to a mixture of acetophenone (5.6 g) in a 100 ml Parr pressure reactor. The mixture was degassed with hydrogen and the pressure was set to 10 atm. The mixture was stirred for 5 hours at 30° C. The NMR spectra of the reaction mixture showed 98% conversion of the ketone to the alcohol.

### Example 34.5. Hydrogenation of Acetophenone Using RuCl₂[(Cy₂PCH₂CH₂)₂NH](t-Bu-NC) as Catalyst

The catalyst (5 mg) is added to a mixture of acetophenone (5.6 g) and KOtBu (10 mg) in a 100 ml Parr pressure reactor. The mixture was degassed with hydrogen and the pressure was set to 10 atm. The mixture was stirred for 5 hours at 30° C. The NMR spectra of the reaction mixture showed complete conversion of the ketone to the alcohol.

### Example 34.6. Hydrogenation of Acetophenone Using RuCl₂[(ⁱPr₂PCH₂CH₂)₂NH](MeO-Ph-NC) as Catalyst

The catalyst (10 mg) is added to a mixture of acetophenone (5.6 g) and KOtBu (10 mg) in a 100 ml Parr pressure reactor. The mixture was degassed with hydrogen and the pressure was set to 20 atm. The mixture was stirred for 5 hours at room temperature. The NMR spectra of the reaction mixture showed complete conversion of the ketone to the alcohol.

### Example 34.7. Hydrogenation of Acetophenone Using RuCl₂[(Ph₂PCH₂CH₂)₂NH](MeO-Ph-NC) as Catalyst

The catalyst (10 mg) is added to a mixture of acetophenone (5.6 g) and KOtBu (20 mg) in a 100 ml Parr pressure reactor. The mixture was degassed with hydrogen and the pressure was set to 20 atm. The mixture was stirred for 18 hours at room temperature. The NMR spectra of the reaction mixture showed 67% conversion of the ketone to the alcohol.

### Example 34. Hydrogenation of Benzylidene Acetone Using Ruthenium Isonitrile Compounds as Catalysts

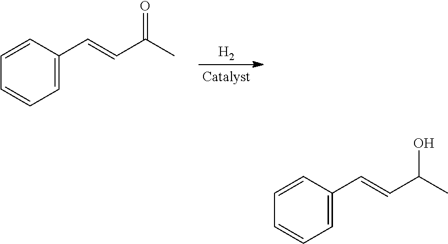

### Example 35.1. Hydrogenation of Benzylidene Acetone Using RuCl₂[(Ph₂PCH₂CH₂)₂NH](t-Bu-NC) as Catalyst

The catalyst (5 mg) is added to a mixture of benzylidene acetone (2.0 g), 2-propanol (10 ml) and KOtBu (10 mg) in a 100 ml Parr pressure reactor. The mixture was degassed with hydrogen and the pressure was set to 10 atm. The mixture was stirred for 5 hours at room temperature. The solvent was then removed under reduced pressure. The NMR spectra of the reaction mixture showed complete conversion of the ketone to the alcohol.

### Example 35.2. Hydrogenation of Benzylidene Acetone Using RuCl₂[(ⁱPr₂PCH₂CH₂)₂NH](t-Bu-NC) as Catalyst

The catalyst (5 mg) is added to a mixture of benzylidene acetone (2.0 g), 2-propanol (10 ml) and KOtBu (10 mg) in a 100 ml Parr pressure reactor. The mixture was degassed with hydrogen and the pressure was set to 10 atm. The mixture was stirred for 5 hours at room temperature. The solvent was then removed under reduced pressure. The NMR spectra of the reaction mixture showed complete conversion of the ketone to the alcohol.

### Example 35.3. Hydrogenation of Benzylidene Acetone Using RuCl₂[(Cy₂PCH₂CH₂)₂NH](t-Bu-NC) as Catalyst

The catalyst (5 mg) is added to a mixture of benzylidene acetone (2.0 g), 2-propanol (10 ml) and KOtBu (10 mg) in a 100 ml Parr pressure reactor. The mixture was degassed with hydrogen and the pressure was set to 10 atm. The mixture was stirred for 5 hours at room temperature. The solvent was then removed under reduced pressure. The NMR spectra of the reaction mixture showed 97% conversion of the ketone to the alcohol.

### Example 36. Hydrogenation of N-(Benzylidene)phenylamine Using Ruthenium Isonitrile Compounds as Catalysts

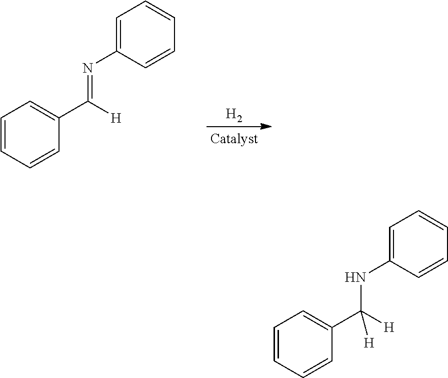 [SMILES: C(=N\c1ccccc1)/c1ccccc1 ; "H2" ; c1ccc(CNc2ccccc2)cc1]

### Example 36.1. Hydrogenation of N-(Benzylidene)phenylamine Using RuCl₂[(Ph₂PCH₂CH₂)₂NH](t-Bu-NC) as Catalyst

The catalyst (10 mg) is added to a mixture of N-(Benzylidene)phenylamine (1.0 g), toluene (2 ml) and KOtBu (10 mg) in a 100 ml Parr pressure reactor. The mixture was degassed with hydrogen and the pressure was set to 10 atm. The mixture was stirred for 12 hours at 50° C. The solvent was then removed under reduced pressure. The NMR spectra of the reaction mixture showed complete conversion of the imine to the amine.

### Example 36.2. Hydrogenation of N-(Benzylidene)phenylamine Using RuCl₂[(ⁱPr₂PCH₂CH₂)₂NH](t-Bu-NC) as Catalyst

The catalyst (10 mg) is added to a mixture of N-(Benzylidene)phenylamine (1.0 g), toluene (2 ml) and KOtBu (10 mg) in a 100 ml Parr pressure reactor. The mixture was degassed with hydrogen and the pressure was set to 10 atm. The mixture was stirred for 12 hours at 50° C. The solvent was then removed under reduced pressure. The NMR spectra of the reaction mixture showed complete conversion of the imine to the amine.

### Example 36.3. Hydrogenation of N-(Benzylidene)phenylamine Using RuCl₂[(Cy₂PCH₂CH₂)₂NH](t-Bu-NC) as Catalyst

The catalyst (10 mg) is added to a mixture of N-(Benzylidene)phenylamine (1.0 g), toluene (2 ml) and KOtBu (10 mg) in a 100 ml Parr pressure reactor. The mixture was degassed with hydrogen and the pressure was set to 10 atm. The mixture was stirred for 12 hours at 50° C. The solvent was then removed under reduced pressure. The NMR spectra of the reaction mixture showed complete conversion of the imine to the amine.

### Example 37. Hydrogenation of Methyl Benzoate Using Ruthenium Isonitrile Compounds as Catalysts

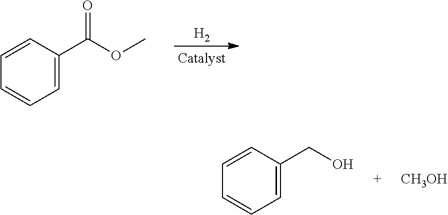

### Example 37.1. Hydrogenation of Methyl Benzoate Using RuCl₂[(Ph₂PCH₂CH₂)₂NH](t-Bu-NC) as Catalyst

The catalyst (10 mg) is added to a mixture of methyl benzoate (200 mg), toluene (1.0 ml) and KOtBu (10 mg) in a 100 ml Parr pressure reactor. The mixture was degassed with hydrogen and the pressure was set to 20 atm. The mixture was stirred for 12 hours at 100° C. It was then cooled to room temperature. The NMR spectra of the reaction mixture showed 80% conversion of the ester to the alcohol.

### Example 37.2. Hydrogenation of Methyl Benzoate Using RuCl₂[(ⁱPr₂PCH₂CH₂)₂NH](t-Bu-NC) as Catalyst

The catalyst (10 mg) is added to a mixture of methyl benzoate (200 mg), toluene (1.0 ml) and KOtBu (10 mg) in a 100 ml Parr pressure reactor. The mixture was degassed with hydrogen and the pressure was set to 20 atm. The mixture was stirred for 12 hours at 100° C. It was then cooled to room temperature. The NMR spectra of the reaction mixture showed 86% conversion of the ester to the alcohol.

### Example 38. Hydrogenation of Diethyl Carbonate Using Ruthenium Isonitrile Compounds as Catalysts

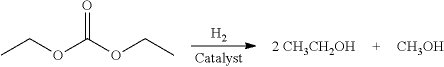

### Example 38.1. Hydrogenation of Diethyl Carbonate Using RuCl₂[(Ph₂PCH₂CH₂)₂NH](t-Bu-NC) as Catalyst

The catalyst (20 mg) is added to a mixture of diethyl carbonate (1.5 g) and KOtBu (10 mg) in a 100 ml Parr pressure reactor. The mixture was degassed with hydrogen and the pressure was set to 20 atm. The mixture was stirred for 12 hours at 120° C. It was then cooled to room temperature. The NMR spectra of the reaction mixture showed 100% conversion of the diethyl carbonate to ethanol and methanol.

### Example 38.2. Hydrogenation of Diethyl Carbonate Using RuCl₂[(ⁱPr₂PCH₂CH₂)₂NH](t-Bu-NC) as Catalyst

The catalyst (20 mg) is added to a mixture of diethyl carbonate (1.5 g) and KOtBu (10 mg) in a 100 ml Parr pressure reactor. The mixture was degassed with hydrogen and the pressure was set to 20 atm. The mixture was stirred for 12 hours at 120° C. It was then cooled to room temperature. The NMR spectra of the reaction mixture showed 100% conversion of the diethyl carbonate to ethanol and methanol.

### Example 39. Hydrogenation of Ethylene Carbonate Using RuCl₂[(Ph₂PCH₂CH₂)₂NH](t-Bu-NC) as Catalyst

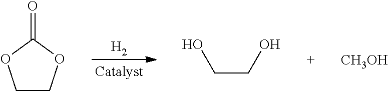

The catalyst (30 mg) is added to a mixture of ethylene carbonate (3.0 g) and KOtBu (10 mg) in a 100 ml Parr pressure reactor. The mixture was degassed with hydrogen and the pressure was set to 20 atm. The mixture was stirred for 12 hours at 120° C. It was then cooled to room temperature. The NMR spectra of the reaction mixture showed 100% conversion of the ethylene carbonate to ethylene glycol and methanol.

### Example 40. Hydrogenation of Propylene Carbonate Using RuCl₂[(Ph₂PCH₂CH₂)₂NH](t-Bu-NC) as Catalyst

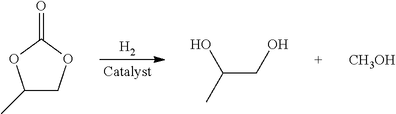

The catalyst (30 mg) is added to a mixture of propylene carbonate (3.0 g) and KOtBu (10 mg) in a 100 ml Parr pressure reactor. The mixture was degassed with hydrogen and the pressure was set to 20 atm. The mixture was stirred for 12 hours at 120° C. It was then cooled to room temperature. The NMR spectra of the reaction mixture showed 100% conversion of the ethylene carbonate to propylene glycol and methanol.

### Example 41. Deuteration of Ethylene Carbonate Using RuCl₂[(Ph₂PCH₂CH₂)₂NH](t-Bu-NC) as Catalyst

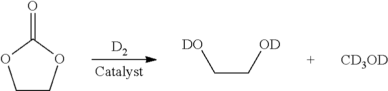

The catalyst (30 mg) is added to a mixture of ethylene carbonate (3.0 g) and KOtBu (10 mg) in a 100 ml Parr pressure reactor. The mixture was degassed with deuterium gas and the pressure was set to 20 atm. The mixture was stirred for 12 hours at 120° C. It was then cooled to room temperature. The NMR spectra of the reaction mixture showed 100% conversion of the ethylene carbonate to ethylene glycol and deuterated methanol.

### Example 42. Deuteration of Propylene Carbonate Using RuCl₂[(Ph₂PCH₂CH₂)₂NH](t-Bu-NC) as Catalyst

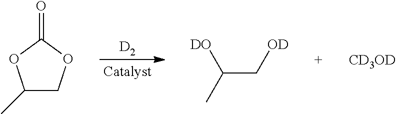

The catalyst (30 mg) is added to a mixture of propylene carbonate (3.0 g) and KOtBu (10 mg) in a 100 ml Parr pressure reactor. The mixture was degassed with deuterium gas and the pressure was set to 20 atm. The mixture was stirred for 12 hours at 120° C. It was then cooled to room temperature. The NMR spectra of the reaction mixture showed 100% conversion of the ethylene carbonate to propylene glycol and deuterated methanol.

### Example 43. Hydrogenation of N,N-bis(2-methoxyethyl)formamide Using RuCl₂[(Ph₂PCH₂CH₂)₂NH](t-Bu-NC) as Catalyst

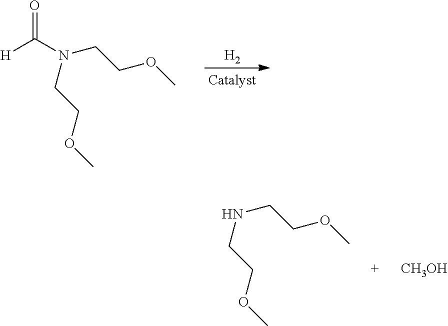

The catalyst (10 mg) is added to a mixture of N,N-bis(2-methoxyethyl)formamide (1.0 g), toluene (1.0 ml) and KOtBu (10 mg) in a 100 ml Parr pressure reactor. The mixture was degassed with hydrogen and the pressure was set to 20 atm. The mixture was stirred for 16 hours at 120° C. It was then cooled to room temperature. The NMR spectra of the reaction mixture showed 85% conversion of the N,N-bis(2-methoxyethyl)formamide to bis(2-methoxyethyl)amine and methanol.

### Example 44. Transfer Hydrogenation of Acetophenone Using Ruthenium Isonitrile Compounds as Catalysts

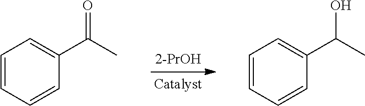

### Example 44.1. Transfer Hydrogenation of Acetophenone Using RuCl₂[(Ph₂PCH₂CH₂)₂NH](t-Bu-NC) as Catalyst

The catalyst (5 mg) is added to a mixture of acetophenone (2.8 g), 2-propanol (20 ml) and KOtBu (10 mg) in a 100 ml Schlenk. The mixture was degassed with argon then refluxed for 6 hours at 82° C. The solvent was removed under reduced pressure. The NMR spectra of the reaction mixture showed 92% conversion of the ketone to the alcohol.

### Example 44.2. Transfer Hydrogenation of Acetophenone Using RuCl₂[(ⁱPr₂PCH₂CH₂)₂NH](t-Bu-NC) as Catalyst

The catalyst (5 mg) is added to a mixture of acetophenone (2.8 g), 2-propanol (20 ml) and KOtBu (10 mg) in a 100 ml Schlenk. The mixture was degassed with argon then refluxed for 6 hours at 82° C. The solvent was removed under reduced pressure. The NMR spectra of the reaction mixture showed 86% conversion of the ketone to the alcohol.

### Example 44.3. Transfer Hydrogenation of Acetophenone Using RuH₂[(ⁱPr₂PCH₂CH₂)₂NH](t-Bu-NC) as Catalyst

The catalyst (5 mg) is added to a mixture of acetophenone (2.8 g) and 2-propanol (20 ml) in a 100 ml Schlenk. The mixture was degassed with argon then refluxed for 6 hours at 82° C. The solvent was removed under reduced pressure. The NMR spectra of the reaction mixture showed 89% conversion of the ketone to the alcohol.

### Example 45. Hydrogenation of Acetophenone Using OsCl₂[(ⁱPr₂PCH₂CH₂)₂NH](MeO-Ph-NC) as Catalyst

The catalyst (10 mg) is added to a mixture of acetophenone (5.6 g) and KOtBu (20 mg) in a 100 ml Parr pressure reactor. The mixture was degassed with hydrogen and the pressure was set to 20 atm. The mixture was stirred for 22 hours at room temperature. The NMR spectra of the reaction mixture showed 34.5% conversion of the ketone to the alcohol.

### Example 46. Catalytic Solvolysis of Ammonia-Borane Using RuCl₂[(^{t}Bu₂PCH₂CH₂)₂NH](MeO-Ph-NC) as Catalyst

A solution of RuCl₂[(^{t}Bu₂PCH₂CH₂)₂NH](MeO-Ph-NC) (10 mg, 1.5×10⁻⁵ mol) in 2-propanol (2 ml) was added in air to 50 ml of a 1:1 (v/v) mixture of 2-propanol/water that had been immersed for five minutes in a water bath held at 45.0° C. Ammonia borane (0.500 g, 1.6×10⁻² mol) was added and the hydrogen released was measured as a function of time. The results are shown in Table 1.

All patents, patent applications, and references cited anywhere in this disclosure are hereby incorporated herein by reference in their entirety.

TABLE 1
Hydrogen generation from ammonia-borane
using RuCl₂[(^{t}Bu₂PCH₂CH₂)₂NH](MeO—Ph—NC)
as catalyst.^{a}

| Time (minutes) | Volume H₂ (ml) |
|---|---|
| 0 | 0 |
| 5 | 210 |
| 10 | 440 |
| 15 | 660 |
| 20 | 840 |
| 25 | 960 |
| 30 | 1060 |
| 35 | 1130 |
| 40 | 1180 |

^{a}RuCl₂[(^{t}Bu₂PCH₂CH₂)₂NH](MeO—Ph—NC) = 10 mg (1.5 × 10⁻⁵ mol); solvent = 50 ml of a 1:1 (v/v) mixture of 2-propanol/water; temperature = 45.0° C.; Ammonia borane = 0.500 g (1.6 × 10⁻² mol).

We claim:

1. A compound of the Formula (I):
[MX₂(PNHP)Y] (I)
wherein, M represents iron, ruthenium or osmium;
X represent, simultaneously or independently, any anionic ligand, including but not limited to hydride, halide, alkoxide, aryloxide, hydroxide, borohydride, carboxylate, among others; and the ligand Y represent an isonitrile ligand of the Formula (II):
R¹—N≡C (II)
in which R¹ represents a hydrogen atom, a linear or branched alkyl group of any length, possibly substituted, or an alkenyl group of any length, possibly substituted, or an alkynyl group, possibly substituted, or a cycloalkyl group, possibly substituted, or an aryl group, possibly substituted, or an heteroaryl group, possibly substituted, with possible and non-limiting substituents of R¹ being halogen atoms, OR^{c}, NR^{c}₂ or R^{c} groups, in which R^{c} is a hydrogen atom or a cyclic, linear or branched alkyl, aryl or alkenyl group; and the ligand (PNHP) represents a tridentate aminodiphosphine ligand of Formula (III): 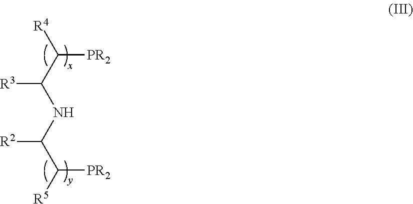
in which R², R³, R⁴ and R⁵ represent simultaneously or independently represent a hydrogen atom, a linear or branched alkyl group of any length, possibly substituted, or an alkenyl group of any length, possibly substituted, or an alkynyl group, possibly substituted, or a cycloalkyl group, possibly substituted, or an aryl group, possibly substituted, or an heteroaryl group, possibly substituted, or two adjacent or geminal groups being bonded together to form a ring including the carbon atom to which said groups are bonded;
indices x and y are, simultaneously or independently, equal to 0, 1, 2, 3 or 4;
and the R groups represent simultaneously or independently a hydrogen atom, a linear or branched alkyl, aryl, or alkenyl group of any length, or an OR or NR₂ group; or the R groups on the same P atom may be bonded together to form a ring having 4 or more atoms and including the phosphorous atom to which said R groups are bonded; with possible and non-limiting substituents of R, R², R³, R⁴ and R⁵ being halogen atoms, OR^{c}, NR^{c}₂ or R^{c} groups, in which R^{c} is a hydrogen atom or a cyclic, linear or branched alkyl, aryl or alkenyl group.

2. A neutral, monocationic or dicationic compound of claim 1.

3. A process for the preparation of a compound of claim 1 comprising contacting a compound of Formula (III); 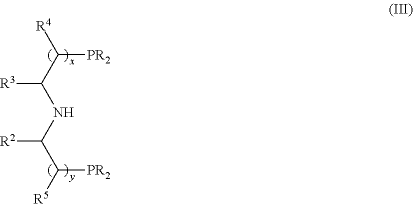
in which R², R³, R⁴ and R⁵ represent simultaneously or independently represent a hydrogen atom, a linear or branched alkyl group of any length, possibly substituted, or an alkenyl group of any length, possibly substituted, or an alkynyl group, possibly substituted, or a cycloalkyl group, possibly substituted, or an aryl group, possibly substituted, or an heteroaryl group, possibly substituted, or two adjacent or geminal groups being bonded together to form a ring including the carbon atom to which said groups are bonded;
wherein indices x and y are, simultaneously or independently, equal to 0, 1, 2, 3 or 4;
and the R groups represent simultaneously or independently a hydrogen atom, a linear or branched alkyl, aryl, or alkenyl group of any length, or an OR or NR₂ group; or the R groups on the same P atom may be bonded together to form a ring having 4 or more atoms and including the phosphorous atom to which said R groups are bonded; with possible and non-limiting substituents of R, R², R³, R⁴ and R⁵ being halogen atoms, OR^{c}, NR^{c}2 or R^{c} groups, in which R^{c} is a hydrogen atom or a cyclic, linear or branched alkyl, aryl or alkenyl group;
with a compound of Formula (II),
R¹—N≡C (II)
in which R¹ represents a hydrogen atom, a linear or branched alkyl group of any length, possibly substituted, or an alkenyl group of any length, possibly substituted, or an alkynyl group, possibly substituted, or a cycloalkyl group, possibly substituted, or an aryl group, possibly substituted, or an heteroaryl group, possibly substituted, with possible and non-limiting substituents of R¹ being halogen atoms, OR^{c}, NR^{c}₂ or R^{c} groups, in which R^{c} is a hydrogen atom or a cyclic, linear or branched alkyl, aryl or alkenyl group;
simultaneously or independently, with a suitable precursor compound including, but are not limited to MX₂, MX₂.xH₂O, MX₃.xH₂O, MX₂(DMSO)₄, [MX₂(cod)]n, MX₂(nbd)]n, [MX₂(benzene)]₂, [MX₂(p-cymene)]₂, [MX₂(mesitylene)]₂, MX₂(PPh₃)₃, MX₄(PPh₃)₃, MX₂(L)(PPh₃)₃; wherein M represents iron, ruthenium or osmium, X represent, simultaneously or independently, any anionic ligand, including but not limited to hydride, halide, alkoxide, aryloxide, hydroxide, borohydride, carboxylate, among others; and L represents any neutral ligand, including but not limited to olefin, phosphine, carbon monoxide, amine, pyridine, among others.

4. A process for the preparation of a compound of claim 1 by contacting a compound of Formula (II);
R¹—N≡C
in which R¹ represents a hydrogen atom, a linear or branched alkyl group of any length, possibly substituted, or an alkenyl group of any length, possibly substituted, or an alkynyl group, possibly substituted, or a cycloalkyl group, possibly substituted, or an aryl group, possibly substituted, or an heteroaryl group, possibly substituted, with possible and non-limiting substituents of R¹ being halogen atoms, OR^{c}, NR^{c}₂ or R^{c} groups, in which R^{c} is a hydrogen atom or a cyclic, linear or branched alkyl, aryl or alkenyl group;
with a metal monomeric compound of formula MX₂(PNHP) or a metal dimeric compound of formula [MX₂(PNHP)]₂, wherein M represents iron, ruthenium or osmium, X represent, simultaneously or independently, any anionic ligand, including but not limited to hydride, halide, alkoxide, aryloxide, hydroxide, borohydride, carboxylate, among others.

5. A use of a compound of claim 1 for catalysis.

6. A process comprising the use of a compound of claim 1 as catalyst for the hydrogenation and transfer hydrogenation of compounds containing one or more carbon-carbon (C═C) double bond, and/or carbon-oxygen (C═O) double bond, and/or carbon-nitrogen (C═N) double bond to the corresponding hydrogenated products.

7. A process comprising the use of a compound of claim 1 as catalyst for the hydrogenation and transfer hydrogenation of compounds of Formula (IV): 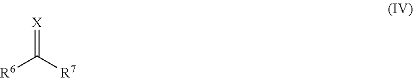
wherein, X represents CR⁸R⁹, NR¹⁰ or O; and R⁶, R⁷, R⁸, R⁹ and R¹⁰ each independently or simultaneously represents a hydrogen atom, a hydroxy radical, an alkoxy or aryloxy group, a cyclic, linear or branched alkyl or alkenyl group of any length, possibly substituted, or an aromatic ring, possibly substituted, or one or more of R⁶, R⁷, R⁸, R⁹ and R¹⁰ optionally being linked in such a way as to form a ring or rings, possibly substituted to provide the corresponding hydrogenated compounds of Formula (V): 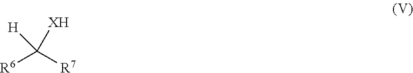
wherein X, R⁶ and R⁷ are defined as in formula (IV); with possible substituents of R⁶ to R⁷ being halogen atoms, OR^{c}, NR^{c}₂ or R^{c} groups, in which R^{c} is a hydrogen atom or a cyclic, linear or branched alkyl, aryl or alkenyl group; and optionally, one or more of the carbon atoms in R⁶ to R⁷ may be substituted with a heteroatom, such as O, S, N, P or Si, which in turn may bear one or more substituents; and since R⁶ and R⁷ may be different, it is hereby understood that the final product, of formula (V), may be chiral, thus possibly consisting of a practically pure enantiomer or of a mixture of stereoisomers, depending on the nature of the catalyst used in the process.

8. A process comprising the use of a compound of claim 1 as catalyst for the hydrogenation and transfer hydrogenation of compounds of Formula (VI): 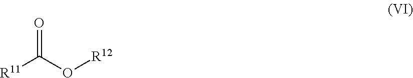
wherein, R¹¹ to R¹² each independently or simultaneously represents a hydrogen atom, a cyclic, linear or branched alkyl or alkenyl group of any length, possibly substituted, or an aromatic ring, possibly substituted, or one or more of R¹¹ to R¹² optionally being linked in such a way as to form a ring or rings, possibly substituted to provide the corresponding hydrogenated compounds of Formula (VII) and Formula (VIII): 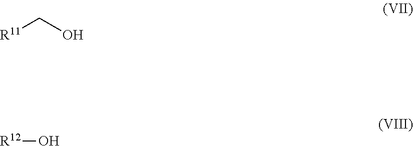
wherein R¹¹ and R¹² are defined as in formula (VI), with possible substituents of R¹¹ to R¹² being halogen atoms, OR^{c}, NR^{c}₂ or R^{c} groups, in which R^{c} is a hydrogen atom or a cyclic, linear or branched alkyl, aryl or alkenyl group; and optionally, one or more of the carbon atoms in R¹¹ to R¹² may be substituted with a heteroatom, such as O, S, N, P or Si, which in turn may bear one or more substituents.

9. A process comprising the use of a compound of claim 1 as catalyst for the hydrogenation and transfer hydrogenation of compounds of Formula (IX): 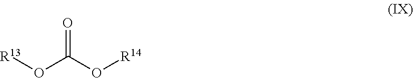
wherein, R¹³ to R¹⁴ each independently or simultaneously represents a hydrogen atom, a cyclic, linear or branched alkyl or alkenyl group of any length, possibly substituted, or an aromatic ring, possibly substituted, or one or more of R¹³ to R¹⁴ optionally being linked in such a way as to form a ring or rings, possibly substituted to provide the corresponding hydrogenated compounds of Formula (X), Formula (XI) and methanol (Formula (XII)):
R¹³—OH (X)
R¹⁴—OH (XI)
H₃C—OH (XII)
wherein R¹³ and R¹⁴ are defined as in formula (IX), with possible substituents of R¹³ to R¹⁴ being halogen atoms, OR^{c}, NR^{c}₂ or R^{c} groups, in which R^{c} is a hydrogen atom or a cyclic, linear or branched alkyl, aryl or alkenyl group; and optionally, one or more of the carbon atoms in R¹³ to R¹⁴ may be substituted with a heteroatom, such as O, S, N, P or Si, which in turn may bear one or more substituents.

10. A process comprising the use of a compound of claim 1 as catalyst for the hydrogenation and transfer hydrogenation of compounds of Formula (XIII): 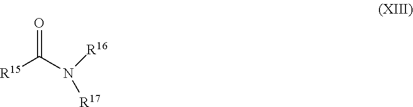
wherein, R¹⁵, R¹⁶ and R¹⁷ each independently or simultaneously represents a hydrogen atom, a cyclic, linear or branched alkyl or alkenyl group of any length, possibly substituted, or an aromatic ring, possibly substituted, or one or more of R¹⁵, R¹⁶ and R¹⁷ optionally being linked in such a way as to form a ring or rings, possibly substituted to provide the corresponding hydrogenated compounds of Formula (XIV) and Formula (XV): 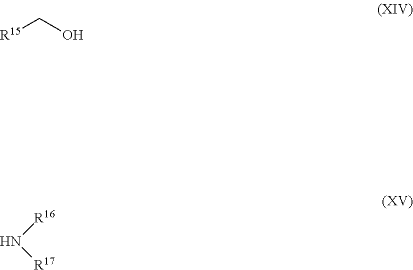
wherein R¹⁵, R¹⁶ and R¹⁷ are defined as in formula (XIII); with possible substituents of R¹⁵, R¹⁶ and R¹⁷ being halogen atoms, OR^{c}, NR^{c}₂ or R^{c} groups, in which R^{c} is a hydrogen atom or a cyclic, linear or branched alkyl, aryl or alkenyl group; and optionally, one or more of the carbon atoms in R¹⁵, R¹⁶ and R¹⁷ may be substituted with a heteroatom, such as O, S, N, P or Si, which in turn may bear one or more substituents.

11. A process for the production of hydrogen comprising:
(a) contacting a solution comprising a compound of claim 1 with at least one amine-borane compound of Formula (XVI),
R¹⁸R¹⁹HNBHR²⁰R²¹ (XVI),
in a solvent under conditions for the dehydrocoupling or the solvolysis of the compound of Formula (XVI),
wherein R¹⁸, R¹⁹, R²⁰ and R²¹ are each simultaneously or independently selected from H, branched or unbranched fluoro-substituted-C₁₋₂₀alkyl, branched or unbranched C₁₋₂₀ alkyl and C₆₋₁₄ aryl or any two of R¹⁸, R¹⁹, R²⁰ and R²¹ are linked to form a branched or unbranched C₂₋₁₀alkylene, which together with the nitrogen and/or boron atoms to which they are attached, forms a ring, and
(b) optionally, collecting hydrogen produced in the dehydrocoupling or the solvolysis of the compounds of Formula (XVI).

12. A process comprising the step of performing a chemical reaction wherein the chemical reaction comprises a compound of claim 1 as catalyst.

13. A process for the hydrogenation and transfer hydrogenation of compounds of Formula (IV): 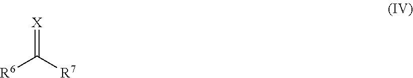
wherein, X represents CR⁸R⁹, NR¹⁰ or O; and R⁶, R⁷, R⁸, R⁹ and R¹⁰ each independently or simultaneously represents a hydrogen atom, a hydroxy radical, an alkoxy or aryloxy group, a cyclic, linear or branched alkyl or alkenyl group of any length, possibly substituted, or an aromatic ring, possibly substituted, or one or more of R⁶, R⁷, R⁸, R⁹ and R¹⁰ optionally being linked in such a way as to form a ring or rings, possibly substituted to provide the corresponding hydrogenated compounds of Formula (V): 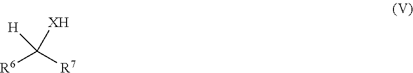
wherein X, R⁶ and R⁷ are defined as in formula (IV); with possible substituents of R⁶ to R⁷ being halogen atoms, OR^{c}, NR^{c}₂ or R^{c} groups, in which R^{c} is a hydrogen atom or a cyclic, linear or branched alkyl, aryl or alkenyl group; and optionally, one or more of the carbon atoms in R⁶ to R⁷ may be substituted with a heteroatom, such as O, S, N, P or Si, which in turn may bear one or more substituents; and since R⁶ and R⁷ may be different, it is hereby understood that the final product, of formula (V), may be chiral, thus possibly consisting of a practically pure enantiomer or of a mixture of stereoisomers, depending on the nature of the catalyst used in the process;
wherein the process comprises a step of performing a chemical reaction comprising a catalyst which is the compound of claim 1.

14. A process for the hydrogenation and transfer hydrogenation of compounds of Formula (VI): 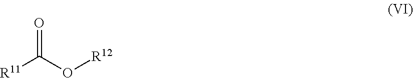
wherein, R¹¹ to R¹² each independently or simultaneously represents a hydrogen atom, a cyclic, linear or branched alkyl or alkenyl group of any length, possibly substituted, or an aromatic ring, possibly substituted, or one or more of R¹¹ to R¹² optionally being linked in such a way as to form a ring or rings, possibly substituted to provide the corresponding hydrogenated compounds of Formula (VII) and Formula (VIII): 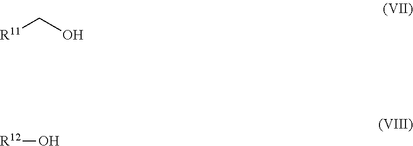
wherein R¹¹ and R¹² are defined as in formula (VI), with possible substituents of R¹¹ to R¹² being halogen atoms, OR^{c}, NR^{c}₂ or R^{c} groups, in which R^{c} is a hydrogen atom or a cyclic, linear or branched alkyl, aryl or alkenyl group; and optionally, one or more of the carbon atoms in R¹¹ to R¹² may be substituted with a heteroatom, such as O, S, N, P or Si, which in turn may bear one or more substituents;
wherein the process comprises a step of performing a chemical reaction comprising a catalyst which is the compound of claim 1.

15. A process for the hydrogenation and transfer hydrogenation of compounds of Formula (IX): 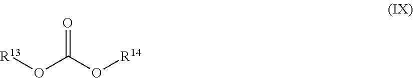
wherein, R¹³ to R¹⁴ each independently or simultaneously represents a hydrogen atom, a cyclic, linear or branched alkyl or alkenyl group of any length, possibly substituted, or an aromatic ring, possibly substituted, or one or more of R¹³ to R¹⁴ optionally being linked in such a way as to form a ring or rings, possibly substituted to provide the corresponding hydrogenated compounds of Formula (X), Formula (XI) and methanol (Formula (XII)):
R¹³—OH (X)
R₁₄—OH (XI)
H₃C—OH (XII)
wherein R¹³ and R¹⁴ are defined as in formula (IX), with possible substituents of R¹³ to R¹⁴ being halogen atoms, OR^{c}, NR^{c}₂ or R^{c} groups, in which R^{c} is a hydrogen atom or a cyclic, linear or branched alkyl, aryl or alkenyl group; and optionally, one or more of the carbon atoms in R¹³ to R¹⁴ may be substituted with a heteroatom, such as O, S, N, P or Si, which in turn may bear one or more substituents;
wherein the process comprises a step of performing a chemical reaction comprising a catalyst which is the compound of claim 1.

16. A process for the hydrogenation and transfer hydrogenation of compounds of Formula (XIII): 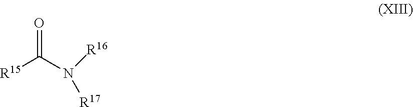
wherein, R¹⁵, R¹⁶ and R¹⁷ each independently or simultaneously represents a hydrogen atom, a cyclic, linear or branched alkyl or alkenyl group of any length, possibly substituted, or an aromatic ring, possibly substituted, or one or more of R¹⁵, R¹⁶ and R¹⁷ optionally being linked in such a way as to form a ring or rings, possibly substituted to provide the corresponding hydrogenated compounds of Formula (XIV) and Formula (XV): 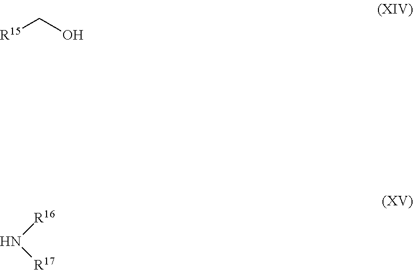
wherein R¹⁵, R¹⁶ and R¹⁷ are defined as in formula (XIII); with possible substituents of R¹⁵, R¹⁶ and R¹⁷ being halogen atoms, OR^{c}, NR^{c}₂ or R^{c} groups, in which R^{c} is a hydrogen atom or a cyclic, linear or branched alkyl, aryl or alkenyl group; and optionally, one or more of the carbon atoms in R¹⁵, R¹⁶ and R¹⁷ may be substituted with a heteroatom, such as O, S, N, P or Si, which in turn may bear one or more substituents;
wherein the process comprises a step of performing a chemical reaction comprising a catalyst which is the compound of claim 1.
